(19) United States
(12) Patent Application Publication
(10) Pub. No.: US 2002/0065667 A1
(43) Pub. Date: May 30, 2002

(54) Dynamic signup

(76) Inventor: Lawrence Kingsley, Cambridge, MA (US)

Correspondence Address: Lawrence Kingsley, 412 Hillcrest Dr., Alexandria, LA, 71301, US

(21) Appl. No.: 09/726,118

(22) Filed: Nov. 30, 2000

(51) Int. Cl. G06F 17/60

(52) U.S. Cl. 705/1

(57) ABSTRACT

Dynamic Signup is an expert system that allows one to register at multiple Web sites or real-world businesses from a single, dynamically-generated registration form. Registration information from each selected site or business is collected and harmonized so that redundancy is eliminated. Since the same information is listed only once, the user is able to speed up the registration process and achieve economies of scale.

### BACKGROUND OF THE INVENTION

This invention applies to software and the World Wide Web. It is particularly applicable to magazine publishing, loan applications, college admission, and other types of application and registration processes.

### BRIEF SUMMARY OF THE INVENTION

Dynamic Signup is an expert system that allows one to register at multiple Web sites or real-world businesses from a single, dynamically-generated registration form. Registration information from each selected site or business is collected and harmonized so that redundancy is eliminated. Since the same information is listed only once, the user is able to speed up the registration process and achieve economies of scale.

### DETAILED DESCRIPTION OF THE INVENTION

Until now, one has had to use cumbersome, often repetitious forms in such areas as bank loans, college applications, or subscriptions to controlled-circulation magazines. Dynamic Signup, however, combines the information requirements of each pertinent category and presents unified indicia, so that duplication is eliminated and the indicia is tailored to the applicant's specified interests.

Controlled-circulation magazines, for example, ask a variety of questions of readers both for the publisher's research purposes and to assure advertisers that the advertising is reaching a well-defined market. These questions vary from publisher to publisher, but often overlap to a significant degree. Dynamic Signup embodies a superset of these questions in each industry. If the reader wishes to subscribe to more than one magazine, a succession of reader qualification forms, one for each magazine, does not have to be completed; instead, the reader checks off the desired magazines from a list of choices and Dynamic Signup presents a blended form that includes only the questions applicable to the selected magazines.

Dynamic Signup not only embodies a superset of attributes, but rules-based logic and collaborative filtering that predict (1) how the user is likely to answer questions and (2) other areas in which the user is likely to have an interest. In the previous example the job function of the reader thus might be used to predict the kind of products for which he or she has budgetary responsibility, a favorite question of publishers. These products would be suggested, subject to the reader's approval or modification. Similarly, the reader profile, especially from multiple magazines, allows Dynamic Signup to predict commercial offers for which the reader should qualify. Dynamic Signup retrieves these offers, presents them to the reader, and either through itself or links to third parties, acts as clearinghouse for this commercial activity.

Rules serve a variety of other functions, such as “if applicant subscribes to E-Week and PC Magazine, 90% of the registration for InfoWorld is already complete—ask the applicant if she wishes InfoWorld as well;” “if applicant is of demographic profile X, she qualifies for commercial offer 5, 7, and 12—show these offers”; “if last update was over six months ago, ask the user if information has changed”; “if applicant is listed in a public directory, applicant is probably not fictitious”; “if applicant lives in Florida, display ad for sun-oriented products like a convertible”; “if applicant lives in Colorado, display ski-oriented advertising”; “deny information to anyone not deliberately designated by the user”.

Underlying Dynamic Signup is a database such as Oracle, and Dynamic Signup is a front-end to this database. The database maintains user information and periodically asks the user if it has changed. When new information is required by the service provider (e.g., publisher, bank, college, Web site), only it is presented, not the entire registration form. In other words, to renew a magazine, the reader no longer has to complete a fresh registration form, with only address information filled in. Instead, known answers from the previous registration are filled in. Similarly, in a new registration Dynamic Signup fills in any known information about the user from any other registration logged by Dynamic Signup. Yet, under password protection, the user has the ability to review the entire profile at any time and to modify it, as required.

Because of privacy concerns, the user has the ability to exclude personal information from any entity not explicitly chosen by the user. The mechanism by which this information is excluded is a simple checkbox or default to “none,” unless overridden by the user. Normally, by checking off something of interest, the user authorizes the sending of profile information to the listed entities. This profile information is displayed before it is sent so that it can be reviewed and edited.

Where the user, by choice or necessity, works offline with paper-based forms, the same technology is used, except that the paper forms are either processed by data entry clerks or scanned via optical character recognition (OCR). Alternatively, if paper forms are desired, the electronic data is faxed or merely printed and mailed to the recipient.

The essence of Dynamic Signup, then, is combination of the following:

1. A menu of choices and computerized means of entering those choices, as on a Web page.

2. The amalgamation of attributes associated with each choice.

3. The presentment of a uniform registration form based on the amalgamation of attributes.

4. The elimination of repetitious information from this form.

5. The fact that the registration form is dynamically-generated: what is included on the form depends on the choices made by the user and the operation of the rules-based system. Thus, there is not just one registration form, but a constantly changing form depending on how the user is interpreted by the system.

6. Automated updating of user information through periodic queries to the user, with the user spared the drudgery of having to re-answer information already known to the system: registration information is restricted to what is new or changed.

7. The predicting of related areas of interest on the basis of the amalgamated attributes.

8. An e-comrnmerce engine that, with the user's approval, acts on the provided information.

What I claim as my invention is the combination of the eight points listed above:

1. Specifically, I claim the origination of a variable registration form derived from expressed and/or known attributes of the user. Instead of having to complete a separate registration for each product, Web site, magazine, or the like, the user completes multiple registrations at once. I also claim originality for the ability of the invention to remember previous registration information so that this information, at the user's option, is entered automatically when it is needed in a new registration. No originality is claimed for expert systems, relational databases, collaborative filtering, OCR, or e-commerce in general, though the combination of this technology in dynamically-generated registration forms is unique.
